(19) United States
(12) Patent Application Publication
(10) Pub. No.: US 2026/0338225 A1
(43) Pub. Date: Oct. 29, 2026

(54) BEARING AND COMPRESSOR

(71) Applicant: TAIHO KOGYO CO., LTD., Toyata-shi, Aichi (JP)

(72) Inventors: Toru KAWAI, Aichi (JP); Naoki HORIBE, Aichi (JP); Kyohei YAMANE, Aichi (JP); Kensaku MATSUMOTO, Aichi (JP)

(73) Assignee: TAIHO KOGYO CO., LTD., Toyata-shi, Aichi (JP)

(21) Appl. No.: 19/117,751

(22) PCT Filed: Oct. 2, 2023
(86) PCT No.: PCT/JP2023/035972

§ 371 Date: Apr. 2, 2025

(30) Foreign Application Priority Data
Oct. 5, 2022 (JP) 2022-161275

(51) Int. Cl. F16C 17/02; F16C 17/12

(52) U.S. Cl. CPC F16C 17/02; F16C 17/12; F16C 2208/32; F16C 2360/00

(57) ABSTRACT

A bearing (10) includes a base material (12) in a tubular shape and a resin layer (14). The resin layer (14) is joined to an inner peripheral surface (C1) of the base material (12), and provided with, on a surface on a facing surface (C2) facing a shaft member accommodated to be opposed to the inner peripheral surface (C1) of the base material (12), a plurality of grooves (MG) running along a direction intersecting the extending direction (Z) of the shaft member. The resin layer (14) contains a synthetic resin (16) and additives (18) dispersed in the synthetic resin (16). The average particle size of the additive (18) is less than the depth (d) of the plurality of grooves (MG).

### FIELD

The present invention relates to a bearing and a compressor.

### BACKGROUND

Thus far, a configuration in which grooves are formed on the surface of the inner peripheral surface of a bearing in a cylindrical shape from the viewpoint of improving seizure resistance by oil holding, etc. has been known. For example, a configuration in which grooves are formed on a bearing layer on a base material is disclosed. Further, a configuration in which a resin layer containing additives such as graphite is used as a bearing layer provided on a base material is disclosed.

### CITATION LIST

### Patent Literature

Patent Literature 1: Japanese Patent No. 5683571
Patent Literature 2: JP 2018-193521 A

### SUMMARY

### Technical Problem

A groove is formed by cutting a resin material layer provided on a base material, or like methods. However, there has been a case where the formation of a groove of a target shape is difficult due to the influence of additives contained in the resin layer. Thus, in conventional technology, there has been a case where normal groove formation cannot be performed and seizure resistance is insufficient.

An object of the present invention is to provide a bearing and a compressor capable of improving seizure resistance.

### Solution to Problem

In order to solve the above problem and achieve the object, a bearing according to the present invention includes: a base material in a tubular shape; and a resin layer joined to an inner peripheral surface of the base material, provided with, on a surface on a facing surface facing a shaft member accommodated to be opposed to the inner peripheral surface of the base material, a plurality of grooves running along a direction intersecting an extending direction of the shaft member, and containing a synthetic resin and an additive dispersed in the synthetic resin, in which an average particle size of the additive is less than a depth of the plurality of grooves.

### Advantageous Effects of Invention

According to the present invention, seizure resistance can be improved.

### BRIEF DESCRIPTION OF DRAWINGS

FIG. 1A is an explanatory diagram of an example of an overall configuration of a bearing of an embodiment.

FIG. 1B is an explanatory diagram of the example of the overall configuration of the bearing of the embodiment.

FIG. 2 is an enlarged cross-sectional view of the example of the bearing.

FIG. 3A is an explanatory diagram of an example of a method for producing a bearing.

FIG. 3B is an explanatory diagram of the example of the method for producing a bearing.

FIG. 4 is an explanatory diagram of an example of a conventional comparative bearing.

FIG. 5 is a schematic diagram of an example of a compressor.

FIG. 6 is an explanatory diagram of a seizure resistance test.

### DESCRIPTION OF EMBODIMENTS

Hereinbelow, embodiments of a bearing and a compressor according to the present invention are described in detail with reference to the accompanying drawings.

The bearing of the present embodiment includes a base material in a tubular shape and a resin layer. The resin layer is joined to the inner peripheral surface of the base material. The resin layer is provided with, on a surface on a facing surface facing a shaft member accommodated to be opposed to the inner peripheral surface of the base material, a plurality of grooves running along a direction intersecting an extending direction of the shaft member, and containing a synthetic resin and an additive dispersed in the synthetic resin. The resin layer contains a synthetic resin and additives dispersed in the synthetic resin. The average particle size of the additive is less than the depth of the groove.

In the bearing of the present embodiment, the average particle size of the additive contained in the resin layer is less than the depth of the groove. Thus, the bearing of the present embodiment allows easy formation of grooves, and can be improve seizure resistance.

Although the reason why the above effect is brought out is not clear, it is surmised as follows. However, the present invention is not limited by the following surmise.

If the average particle size of the additive contained in the resin layer is equal to or more than the depth of the groove, it is presumed that the formation of a groove of a target shape may be difficult. Further, if the average particle size of the additive contained in the resin layer is equal to or more than the depth of the groove, fallen portions formed by the additive falling off during processing of grooves may form large defects in the shape of the groove, and there may be a case where a groove of a target shape is not formed. If the formation of a groove of a target shape is difficult, it is presumed that bearing performance including seizure resistance cannot be stably exhibited, and a problem arises in quality as a bearing product. Further, if the average particle size of the additive contained in the resin layer is equal to or more than the depth of the groove, there may be a case where a predetermined groove shape is not maintained during sliding with the shaft member.

On the other hand, when the average particle size of the additive contained in the resin layer is less than the depth of the groove, it is surmised that a groove of a target shape is suitably formed. Further, it is surmised that by forming a groove of a target shape, a suitable oil film holding force of lubricating oil based on the groove is achieved and lubrication performance is improved, and seizure resistance can be improved.

Hereinbelow, the bearing and the compressor of the present embodiment are described in detail.

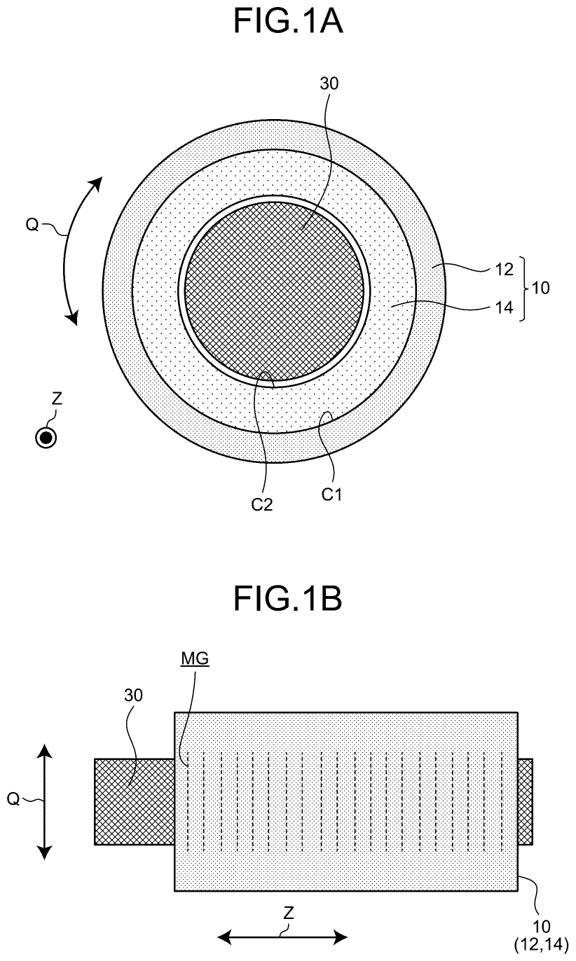

FIGS. 1A and 1B are explanatory diagrams of an example of an overall configuration of a bearing 10 of the present embodiment. FIG. 1A is a cross-sectional view of the bearing 10 taken along a direction intersecting the extending direction Z of the bearing 10. FIG. 1B is an external appearance view of the bearing 10 as viewed from a direction intersecting the extending direction Z of the bearing 10.

The bearing 10 includes a base material 12 and a resin layer 14.

The base material 12 is a tubular member. In the present embodiment, a form in which the base material 12 is a cylindrical member is described as an example. The base material 12 needs only to be in a tubular shape, and is not limited to a cylindrical shape.

The base material 12 is a member for accommodating a shaft member 30 on the inner peripheral surface C1 side. The shaft member 30 is a rod-like member that is long in the extending direction Z. In the present embodiment, a form in which the extending direction Z of the base material 12 and the extending direction Z of the shaft member 30 coincide with each other is described as an example. The extending direction Z of the base material 12 and the extending direction Z of the shaft member 30 may not coincide with each other.

The resin layer 14 is a layer joined to the inner peripheral surface C1 of the base material 12. A surface of the resin layer 14 on the facing surface C2 side, the facing surface C2 facing the shaft member 30, is provided with a plurality of grooves MG running along a direction intersecting the extending direction Z of the shaft member 30. The groove MG running along a direction intersecting the extending direction Z means a groove MG extended along a direction intersecting the extending direction Z.

The groove MG needs only to be provided along a direction intersecting the extending direction Z of the shaft member 30, and may be either of a direction orthogonal to the extending direction Z and a direction inclined at an angle less than 90° with respect to the orthogonal direction. In the present embodiment, a form in which the groove MG is provided along a direction orthogonal to the extending direction Z of the shaft member 30, that is, along the circumferential direction Q of the bearing 10 in a cylindrical shape is described as an example. A configuration in which a groove MG is continuously formed in a spiral shape from one end portion to another end portion in the extending direction Z of the resin layer 14 is possible. Also a configuration in which the resin layer 14 is provided with, from its one end side toward its other end side in the extending direction Z, a plurality of grooves MG that are discontinuous from each other is possible.

Next, details of the bearing 10 are described.

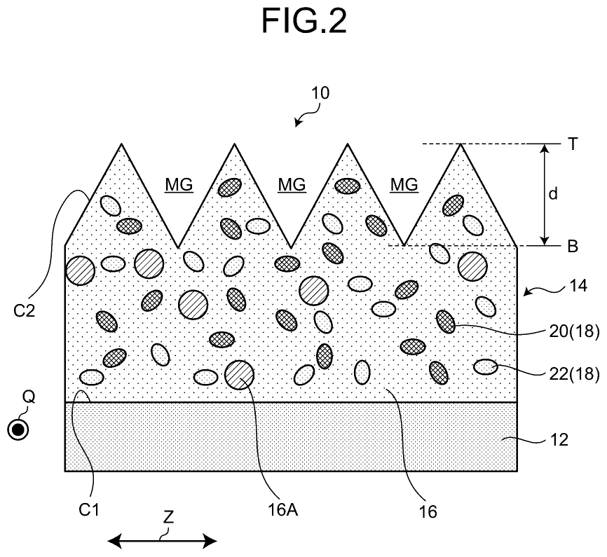

FIG. 2 is an enlarged cross-sectional view of an example of the bearing 10.

The bearing 10 is a stacked body of the base material 12 and the resin layer 14 formed on the base material 12.

The base material 12 is a layer for providing mechanical strength to the bearing 10. The base material 12 may be referred to as a back metal or a back metal layer. As the base material 12, for example, a metal plate of an Fe alloy, Cu, a Cu alloy, or the like can be used.

At least a partial region of the base material 12 on the contact surface side, the contact surface contacting with the resin layer 14, may be formed by a sintered layer. The sintered layer is a sintered body of metal powder, and is a porous layer having a plurality of pores. The metal powder forming the sintered layer may be the same metal as the base material 12, or may be a metal or a material different from the base material 12. By using a configuration including a sintered layer, adhesion between the base material 12 and the resin layer 14 can be improved.

The resin layer 14 is, as described above, a layer joined to the inner peripheral surface C1 of the base material 12. As described above, a surface of the resin layer 14 on the facing surface C2 side, the facing surface C2 facing the shaft member 30, is provided with the groove MG.

The groove MG is a micro-level fine, precise grooved portion formed on the surface of the resin layer 14. The groove MG may be referred to as a micro groove.

The shape of the groove MG is not limited. The groove MG needs only to be in a shape that can hold lubricating oil supplied at the time of rotational driving of the bearing 10 or on like occasions and that can hold the oil between the groove MG and the shaft member 30.

FIG. 2 illustrates, as an example, a form in which the cross-sectional shape of the groove MG is a V-shape. However, the cross-sectional shape of the groove MG is not limited to a V-shape. For example, the cross-sectional shape of the groove MG may be a U-shape, a shape composed of a flat bottom portion and a pair of side wall portions erected with respect to the bottom portion, or the like.

The depth d of the groove MG and the width of the groove MG are not limited. The depth d and the width of the groove MG need only to be a depth and a width with which lubricating oil supplied at the time of rotational driving of the bearing 10 or on like occasions can be held and the oil can be held between the groove MG and the shaft member 30.

The depth d of the groove MG refers to the distance in the thickness direction of the resin layer 14 between the bottom B of the groove MG and the apex T of the peak of the groove MG. The width of the groove MG refers to the distance between the centers of the bottoms B of adjacent grooves MG.

The depth d of the groove MG is, for example, in the range equal to or more than 4.0 μm and equal to or less than 7.0 μm, or the like, but is not limited to this range. The width of the groove MG is, for example, in the range equal to or more than 0.045 mm and equal to or less than 0.145, preferably equal to or more than 0.075 mm and equal to or less than 0.095 mm, or the like, but is not limited to this range. The grooves MG are continuously formed in the width direction.

The resin layer 14 is a layer containing a resin material as a main component. Specifically, the resin layer 14 is composed of a synthetic resin 16 and additives 18 dispersed in the synthetic resin 16.

The composition of the synthetic resin 16 is not limited. The composition of the synthetic resin 16 is preferably composed of a heat-resistant resin from the viewpoint of improving abrasion resistance or the like.

For example, the synthetic resin 16 contains PTFE (polytetrafluoroethylene). In the present embodiment, a form in which PTFE particles 16A that are particulate PTFE are dispersed in the synthetic resin 16 is described as an example.

The content amount of PTFE particles 16A in the synthetic resin 16 is not limited. For example, the content amount of PTFE particles 16A in the synthetic resin 16 is preferably equal to or more than 5 volume % and equal to or less than 30 volumes, more preferably equal to or more than 10 volumes and equal to or less than 25 volumes, and particularly preferably equal to or more than 12 volume % and equal to or less than 20 volume %.

When the content amount of PTFE particles 16A in the synthetic resin 16 is in the above range, the frictional coefficient of the resin layer 14 can be reduced. Further, the PTFE particles 16A have high heat resistance, and are difficult to melt and decompose. Thus, by using a configuration in which PTFE particles 16A are incorporated in the synthetic resin 16, the frictional coefficient of the resin layer 14 can be effectively reduced. That is, by containing PTFE particles 16A, the seizure resistance of the bearing 10 can be further improved.

The average particle size of the PTFE particles 16A is not limited. The average particle size of the PTFE particles 16A may be either of equal to or more than the depth d of the groove MG, and less than the depth d of the groove MG. Specifically, the average particle size of the PTFE particles 16A is, for example, preferably equal to or more than 1.0μ and equal to or less than 25.0 μm, more preferably equal to or more than 1.0 μm and equal to or less than 15.0 μm, and particularly preferably equal to or more than 0.2 μm and equal to or less than 12.0 μm.

When the average particle size of the PTFE particles 16A is in the above range, the total area of the surface area of the PTFE particles 16A dispersed in the synthetic resin 16 is increased. Thus, even when the content amount of PTFE particles 16A is a smaller content amount within the above range, the frictional coefficient of the resin layer 14 can be reduced, and the seizure resistance of the resin layer 14 can be improved.

The average particle size of the PTFE particles 16A refers to the average primary particle size of the PTFE particles 16A. The average primary particle size refers to a cumulative 50% volume-average particle size. A scanning electron microscope (SEM) can be used for the measurement of the average particle size of the PTFE particles 16A. The particles of the PTFE particles 16A are observed by SEM observation at an appropriate magnification (for example, about 5000 times), and the diameter of each of 100 primary particles is measured to calculate the volume of the primary particle; the cumulative 50% particle size can be taken as the average primary particle size. When the particle of the PTFE particle 16A is not spherical, the average value of the major axis and the minor axis is regarded as the diameter of the primary particle.

The shape of the PTFE particle 16A is not limited. For example, the shape of the PTFE particle 16A may be either of spherical and prolate spheroidal. The method for producing PTFE particles 16A is not limited. For example, any of PTFE particles produced by a suspension polymerization method, PTFE particles produced by an emulsion polymerization method, and regenerated PTFE particles may be used as the PTFE particles 16A.

The synthetic resin 16 may be a configuration further containing one or two or more selected from PI (polyimides), PAI (polyamide-imides), PBI (polybenzimidazole), PA (polyamides), phenol, epoxy, POM (polyacetal), PEEK (polyether ether ketone), PE (polyethylene), PPS (polyphenylene sulfide), and PEI (polyetherimide).

The synthetic resin 16 may be a configuration further containing a silane coupling agent from the viewpoint of strengthening the bond with the additive 18.

Next, the additive 18 is described.

The additive 18 is a substance for improving the characteristics of the resin layer 14. In the present embodiment, the additive 18 means a substance other than resins. That is, no resin is contained in the additive 18.

The average particle size of the additive 18 of the present embodiment is less than the depth d of the groove MG. For example, it is essential that the average particle size of the additive 18 be less than once the depth d of the groove MG, and the average particle size is preferably less than ¾ times the depth d of the groove MG, and more preferably less than ½ times the depth d of the groove MG.

When the average particle size of the additive 18 is less than the depth d of the groove MG, it is presumed that a groove MG of a target shape is suitably formed during production of the bearing 10B. It is presumed that by a groove MG of a target shape being suitably formed, a suitable lubricating oil holding force based on the groove MG can be obtained and seizure resistance can be improved.

The average particle size of the additive 18 may be measured by the following method. Specifically, for example, an electron image in which a cross section in a direction along the extending direction Z of the resin layer 14 is photographed using an electron microscope at an appropriate magnification (for example, 1000 times) is obtained. Then, the areas of particles of the additive 18 included in the obtained electron image are measured by a general image analysis technique for each kind of the additives 18, and are converted to the average diameter on the assumption that the area is a circle. The average particle size of each kind of the additives 18 may be determined by these pieces of processing.

The additive 18 specifically includes at least one of graphite 20 and clay 22.

By the additive 18 including graphite 20, an improvement in the seizure resistance of the resin layer 14, etc. can be achieved.

The average particle size of the additive 18 such as the graphite 20 needs only to be less than the depth d of the groove MG, as described above. For example, it is assumed that the depth d of the groove MG is in the range equal to or more than 4.0 μm and equal to or less than 7.0 μm. In this case, the average particle size of the graphite 20 is, for example, preferably equal to or more than 1.0 μm and less than 4.0 μm, and preferably equal to or more than 1.0 μm and less than 2.0 μm.

The content amount of the graphite 20 in the synthetic resin 16 is not limited. The content amount of the graphite 20 in the synthetic resin 16 is, for example, preferably equal to or more than 1 volume % and less than 15 volume %, more preferably equal to or more than 3 volumes and equal to or less than 12 volumes, and particularly preferably equal to or more than 5 volumes and less than 9 volume %.

When the content amount of the graphite 20 in the synthetic resin 16 is within the above range, the lipophilicity of the resin layer 14 can be improved, and seizure resistance can be further improved.

The shape of the graphite 20 is not limited. For example, the shape of the graphite 20 may be either of scaly and spherical. The shape of the graphite 20 is preferably scaly.

The scaly shape means that the shape is a scale-like shape. The scale-like graphite 20 is a crystal in which a large number of AB surfaces (hexagonal mesh flat surfaces, basal surfaces) that are spread in a planar shape by carbon atoms regularly forming a network structure are stacked and that has a thickness in the C-axis direction perpendicular to the AB surface. Since the bonding force due to van der Waals force between stacked AB surfaces is much smaller than the bonding force in the in-plane direction of the AB surface, shearing is likely to occur between AB surfaces. Thus, the scaly graphite 20 has a thin thickness in the stacking direction with respect to the spread of the AB surface, and forms a thin plate shape as a whole.

The scaly graphite 20 functions as a solid lubricant by shearing between AB surfaces occurring upon receiving an external force. Thus, by using scaly graphite 20 as the graphite 20 dispersed in the synthetic resin 16, the seizure resistance of the resin layer 14 can be further improved.

The degree of graphitization of the graphite 20 is preferably high from the viewpoint of reducing the frictional coefficient. For example, the degree of graphitization of the graphite 20 is preferably equal to or more than 95%, and more preferably equal to or more than 99%.

The clay 22 is Al₂O₃—SiO₂—H₂O-based clay minerals in general. The clay 22 may be fired clay. By the additive 18 including clay 22, the abrasion resistance of the resin layer 14 can be improved.

The average particle size of the clay 22 needs only to be less than the depth d of the groove MG, as described above. For example, it is assumed that the depth d of the groove MG is in the range equal to or more than 4.0 μm and equal to or less than 7.0 μm. In this case, the average particle size of the clay 22 is, for example, preferably equal to or more than 2.0 μm and equal to or less than 4.0 μm, and preferably equal to or more than 2.0 μm and less than 3.5 μm.

The content amount of the clay 22 in the synthetic resin 16 is not limited. The content amount of the clay 22 in the synthetic resin 16 is, for example, preferably equal to or more than 1 volume % and equal to or less than 5 volume %, and more preferably equal to or more than 1 volume % and equal to or less than 3 volumes. When the content amount of the clay 22 is in the above range, the abrasion resistance of the resin layer 14 can be improved, and a reduction in fatigue resistance can be suppressed.

### (Method for Producing a Bearing)

The bearing 10 of the present embodiment is produced by, for example, the following steps.

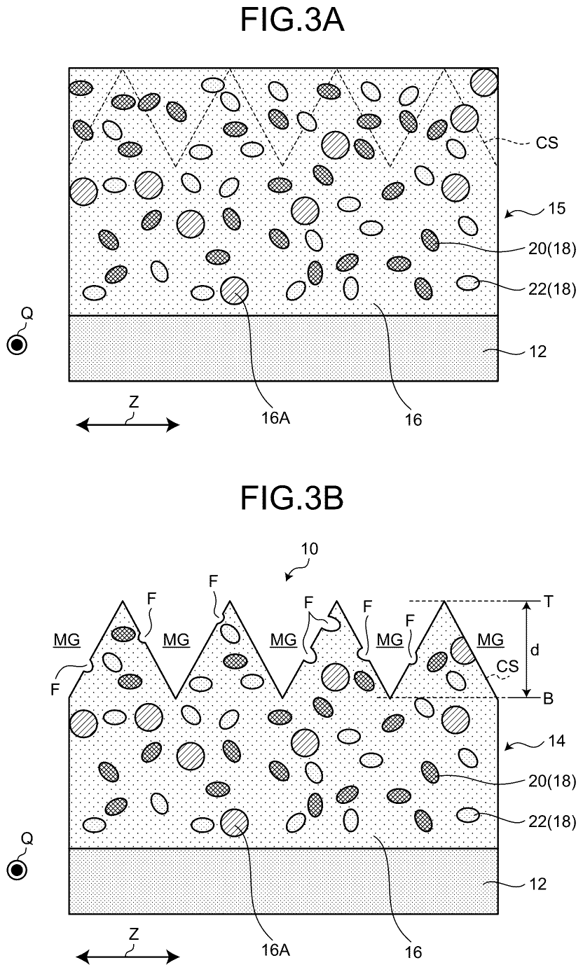

FIGS. 3A and 3B are explanatory diagrams of an example of a method for producing the bearing 10.

As illustrated in FIG. 3A, the constituent materials of the resin layer 14 of the above configuration is applied onto a base material 12, and thereby a resin material layer 15 is formed (a resin material layer formation step). Then, the resin material layer 15 formed on the base material 12 is dried. Known conditions may be used as application conditions and drying conditions.

Then, next, a groove processing step is executed. In the groove processing step, the edge of a cutting tool is moved along the surface of the resin material layer 15, and thereby the surface of the resin material layer 15 is scraped off along a cutting surface CS of a groove MG of a target shape. By the groove processing step, as illustrated in FIG. 3B, a bearing 10 including a resin layer 14 in which a groove MG is formed is produced.

The formation of the groove MG is not limited to formation by cutting the resin material layer 15 with a cutting tool. For example, the groove MG may be formed by etching, a roller, or the like.

Here, additives 18 are contained in the resin material layer 15. The larger the relative size of the additive 18 contained in the resin material layer 15 with respect to the groove MG is, the more difficult the processing of the groove MG may be. However, as described above, in the present embodiment, the average particle size of the additive 18 is less than the depth d of the groove MG. Thus, in the present embodiment, even when additives 18 are contained in the resin material layer 15, the groove MG can be easily formed.

During formation of the groove MG, the additive 18 may fall off the resin layer 14 due to the cutting of the resin material layer 15 or the like, and fallen portions F may be formed on the surface of the resin layer 14 (see FIG. 3B). However, as described above, in the present embodiment, the average particle size of the additive 18 is less than the depth d of the groove MG. Thus, even when fallen portions F are formed on the surface of the resin layer 14 due to falling of the additive 18 during formation of the groove MG, the shape of the groove MG in the bearing 10 of the present embodiment substantially maintains the target shape (see FIG. 3B). That is, in the present embodiment, a bearing 10 having a groove MG in which the rate of shape defects with respect to the target shape is suppressed (that is, a normal groove MG) can be produced.

On the other hand, in a conventional bearing in which the average particle size of the additive 18 is equal to or more than the depth d of the groove MG, there has been a case where it is difficult to form a groove MG of a target shape.

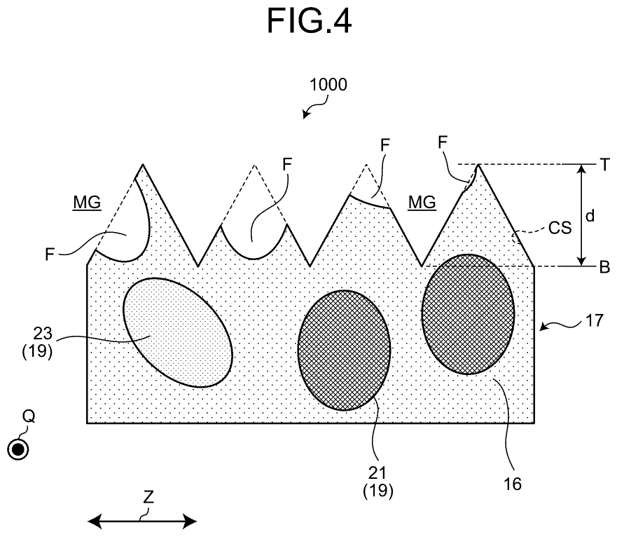

FIG. 4 is an explanatory diagram of an example of a comparative bearing 1000. In the comparative bearing 1000, the average particle size of an additive 19 such as graphite 21 or clay 23 dispersed in a synthetic resin 16 of a comparative resin layer 17 is equal to or more than the depth d of a groove MG. Thus, in the comparative bearing 1000, the relative size of the additive 19 with respect to the groove MG is large, and there has been a case where it is difficult to perform processing of the groove MG on the surface of the resin material layer of the comparative resin layer 17.

Further, in the comparative bearing 1000, the relative size of a fallen portion F formed by the additive 19 falling off during formation of the groove MG with respect to the groove MG is large, and as a result there has been a case where a groove MG of a shape greatly deformed from a target shape is formed (see FIG. 4). Thus, in the comparative bearing 1000, it is presumed that a normal groove MG cannot be provided and it is difficult to bring out stable bearing performance, and a problem arises in quality as a bearing product.

On the other hand, in the bearing 10 of the present embodiment, the average particle size of the additive 18 is less than the depth d of the groove MG. Thus, in the present embodiment, even when additives 18 are contained in the resin material layer 15, the groove MG can be easily formed. Further, as illustrated in FIG. 3B, in the bearing 10 of the present embodiment, the rate of shape defects with respect to the target shape of the groove MG is smaller than in the conventional comparative bearing 1000, and it is presumed that a bearing 10 including a groove MG that is closer to or coincides more with the target shape can be produced.

Thus, in the present embodiment, it is presumed that by a groove MG of a target shape being formed, a suitable lubricating oil holding force based on the groove MG can be obtained and the seizure resistance of the bearing 10 can be improved.

### (Compressor)

Next, an example of an application form of the bearing 10 is described. The bearing 10 is used as, for example, a bushing in a fuel injection pump, various bearings, a compressor, or the like.

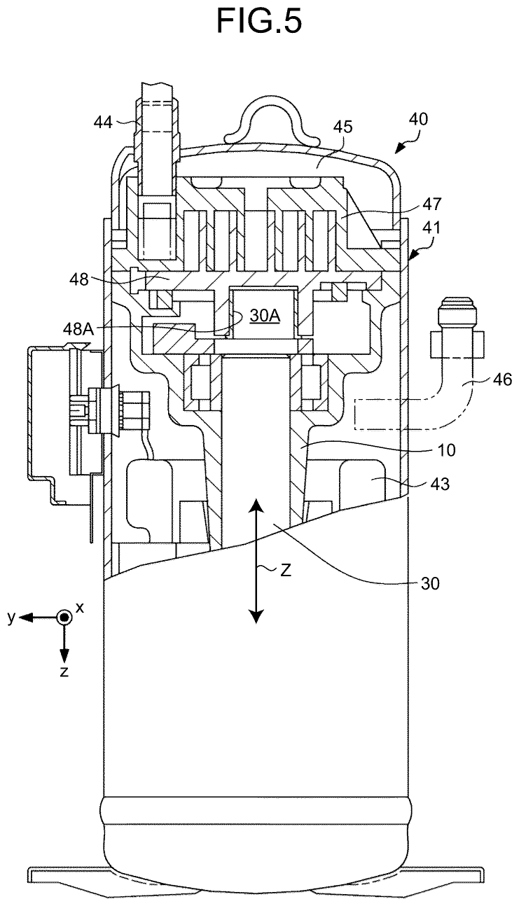

FIG. 5 is a schematic diagram of an example of a compressor 40. The compressor 40 is an example of an application form of the bearing 10. FIG. 5 illustrates a scroll compressor as an example. The scroll compressor is used for compression of a gas such as a refrigerant gas in an air conditioner for an automobile, a household, a railroad, or a business, for example.

The compressor 40 includes a cylindrical housing 41 with both ends closed. For example, the center of the housing 41 is placed along a z-axis. The z-axis direction coincides with a direction parallel to the vertical direction. The +z direction is a vertical direction, and may be referred to as upper. The −z direction is an anti-vertical direction, and may be referred to as lower.

A suction pipe 44 for sucking the atmosphere is provided over (in the −z direction of) the housing 41. A discharge pipe 46 for discharging compressed air stored in a chamber 45 in the housing 41 is provided on a side surface of the housing 41. In the interior of the housing 41, a bearing 10 fixed to the housing 41 and a shaft member 30 rotatably supported by the bearing 10 are placed in a direction along the z-axis. That is, FIG. 5 illustrates, as an example, a form in which the extending directions Z of the shaft member 30 and the bearing 10 and the z-axis direction, which is a direction parallel to the vertical direction, coincide with each other. In other words, FIG. 5 describes, as an example, a form in which the compressor 40 is a vertical compressor.

A fixed scroll member 47 provided with a spiral blade is fixed to an upper portion of the interior of the housing 41 of the compressor 40. On the lower side of the fixed scroll member 47, a movable scroll member 48 provided with a spiral blade having the opposite winding direction to the blade of the fixed scroll member 47 is placed to face the fixed scroll member 47. The movable scroll member 48 forms a compression chamber together with the fixed scroll member 47.

The shaft member 30 has a crank pin 30A at the upper part. When the shaft member 30 is rotationally driven by a motor 43 provided in the interior of the housing 41, the crank pin 30A turns. The crank pin 30A is accommodated in a pin receiver 48A provided under the movable scroll member 48, and turns the movable scroll member 48 by turning itself.

When the movable scroll member 48 turns, the atmosphere sucked from the suction pipe 44 flows into the compression chamber formed by the movable scroll member 48 and the fixed scroll member 47 and is compressed, and is stored in the chamber 45. The compressor 40 discharges the compressed air stored in the chamber 45 from the discharge pipe 46 to the outside.

In general, a compressor 40 (an air conditioner compressor) that compresses a refrigerant contains lubricating oil (refrigerating machine oil) in the refrigerant, and supplies the lubricating oil to each bearing 10 by circulation of the refrigerant. In the stopped state, since the refrigerant does not circulate, the lubricating oil is not supplied. Therefore, in the period from the stop to the beginning of starting, lubrication of the bearing 10 is performed only by oil held (adhered) between the bearing 10 and the shaft member 30.

At the time of the starting of the compressor 40, lubrication is performed with oil held between the bearing 10 and the shaft member 30, and the shaft member 30 is rotationally driven. If this oil is depleted before the refrigerant circulates, seizure occurs.

In the bearing 10 of the present embodiment, a groove MG is provided on the facing surface C2 of the resin layer 14 facing the shaft member 30.

Thus, oil holding force for the lubricating oil that has entered the gap between the bearing 10 and the shaft member 30 is increased by the groove MG provided in the resin layer 14. Thus, it is presumed that the resin layer 14 of the bearing 10 and the shaft member 30 are lubricated at the time of the starting of the compressor 40 and that a situation where oil shortage occurs at the beginning of the rotation starting of the shaft member 30 and seizure is caused is suppressed.

Therefore, it is presumed that the compressor 40 including the bearing 10 of the present embodiment can improve seizure resistance.

FIG. 5 illustrates, as an example, a form in which the compressor 40 is a vertical compressor. However, the compressor 40 may be a horizontal compressor in which the extending directions Z of the shaft member 30 and the bearing 10 coincide with the horizontal direction. Further, the compressor 40 may be a form in which the extending directions Z of the shaft member 30 and the bearing 10 are placed in directions intersecting both the horizontal direction and the vertical direction.

The timing of forming the groove MG is not limited. For example, the groove MG may be formed before the bearing 10 is attached to the compressor 40. That is, the compressor 40 may be produced by a process in which a bearing 10 in which a groove MG is formed is attached to the compressor 40.

Further, the groove MG may be formed by a process in which a bearing 10 including a resin material layer 15 in which a groove MG is not formed is attached to the compressor 40 and then a groove processing step is performed on the resin material layer 15. As described above, in the bearing 10 of the present embodiment, the average particle size of the additive 18 contained in the resin material layer 15 is less than the depth d of the groove MG to be formed. Thus, in the present embodiment, even when additives 18 are contained in the resin material layer 15, the groove MG can be easily formed. That is, in the present embodiment, even in the case where the groove MG is formed after the bearing 10 is attached to the compressor 40, a groove MG of a target shape can be formed with ease and high accurately.

### EXAMPLES

The present invention will now be specifically described with reference to Examples, but the present invention is not limited to these Examples.

The following test pieces including resin layers 14 and comparative resin layers were produced, and seizure resistance was evaluated for these test pieces.

### —Production of a Test Piece—

A steel plate (SPCC (JIS)) having a thickness of 1.5 mm was prepared as a base material 12. A solution of constituent materials of the resin layer 14 in which the additives illustrated in each of Examples 1 to 3 of Table 1 were added to the synthetic resins of the composition illustrated in the respective one of Examples 1 to 3 of Table 1 was prepared. Then, this solution was applied onto the base material 12 by a knife coating method. After the application, drying was performed in the range of room temperature to about 200 °C for 60 minutes to 90 minutes. After that, the temperature was increased to about 300 °C, and firing was performed for 30 minutes to 90 minutes. By these steps, a resin material layer 15 was formed on the base material 12. Further, the edge of a cutting tool was moved along the surface of the resin material layer 15, and thereby the surface of the resin material layer 15 was scraped off along a cutting surface CS of a groove MG of a target shape. The target shape was set to a V-shaped cross-sectional shape having a depth d of the groove MG of 4.0 μm and a width of the groove MG of 0.075 μm.

By these pieces of processing, a test piece of the resin layer 14 of each of Examples 1 to 3 was produced.

Further, test pieces of comparative resin layers 17 of Comparative Examples 1 to 3 were produced in a similar manner to the resin layers 14 of Examples 1 to 3 except that the synthetic resins and the additives illustrated in Comparative Examples 1 to 3 of Table 1 were used as constituent materials of the comparative resin layers 17.

As the graphite, scaly graphite having a degree of graphitization of 99% was used. As the clay, clay having a structural formula of Al₂O₃·2SiO₂ was used.

TABLE 1

| | Resin layer | | | | | | | | Relationship | | |
|---|---|---|---|---|---|---|---|---|---|---|---|
| | Content amount of | | | | | | | | between groove | Evaluation | |
| | component [volume %] | | | | Average particle | | Groove shape | | depth d and | Elapsed time | Result of |
| | Synthetic resin | | Additive | | size [μm] | | Depth | Width | average particle | until seizure | groove shape |
| | PI | PTFE | Graphite | Clay | Graphite | Clay | [μm] | [mm] | size K of additive | [seconds] | determination |
| Example 1 | Balance | 15.0 | 6.0 | 1.5 | 3.9 | 3.0 | 4.0 | 0.075 | K < d | 84 | MG processing |
| | | | | | | | | | | | was performed |
| | | | | | | | | | | | (shape being |
| | | | | | | | | | | | normal) |
| Example 2 | Balance | 17.0 | 7.0 | 2.0 | 1.0 | 2.0 | 4.0 | 0.075 | | 129 | MG processing |
| | | | | | | | | | | | was performed |
| | | | | | | | | | | | (shape being |
| | | | | | | | | | | | normal) |
| Comparative | Balance | 15.0 | 7.0 | 2.0 | 5.0 | 5.0 | — | — | K ≥ d | 48 | MG processing |
| Example 1 | | | | | | | | | | | was not |
| | | | | | | | | | | | performed |

TABLE 2

| | Resin layer | | | | | | | | Relationship | | |
|---|---|---|---|---|---|---|---|---|---|---|---|
| | Content amount of | | | | | | | | between groove | Evaluation | |
| | component [volume %] | | | | Average particle | | Groove shape | | depth d and | Elapsed time | Result of |
| | Synthetic resin | | Additive | | size [μm] | | Depth | Width | average particle | until seizure | groove shape |
| | PI | PTFE | Graphite | Clay | Graphite | Clay | [μm] | [mm] | size K of additive | [seconds] | determination |
| Example 3 | Balance | — | 6.0 | — | 2.0 | — | 4.0 | 0.075 | K < d | — | Shape being |
| | | | | | | | | | | | normal |
| Comparative | Balance | — | 6.0 | — | 12.0 | — | 4.0 | 0.075 | K ≥ d | — | Shape being |
| Example 2 | | | | | | | | | | | abnormal |
| Comparative | Balance | — | 6.0 | — | 28.0 | — | 4.0 | 0.075 | | — | Shape being |
| Example 3 | | | | | | | | | | | abnormal |

### —Evaluation—

### —Seizure Resistance—

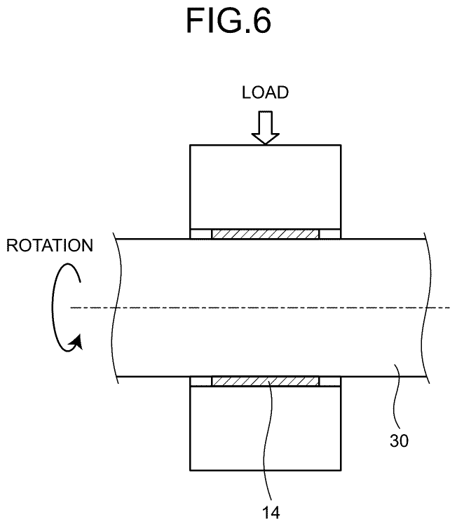

Seizure resistance was evaluated for the test pieces of Examples and the test piece of a Comparative Example. The evaluation of seizure resistance was performed using a testing machine illustrated in FIG. 6.

FIG. 6 is an explanatory diagram of a seizure resistance test. The groove MG side of the test piece corresponding to each of the resin layer 14 and the comparative resin layer 17 was placed to face the shaft member 30, and 45 mg of lubricating oil was applied to the surface on the groove MG side. Then, the shaft member 30 was rotated while a load was applied; thereby, seizure resistance was evaluated. The evaluation was performed under the following conditions.
Testing machine: a seizure testing machine (see FIG. 6)
Load: 5 MPa
Rotation speed (peripheral speed): 2 m/s
Testing temperature (ambient temperature): 40 °C
Material of the shaft member 30: SCM 415 (Hv: 500 or higher)
Surface roughness Ra of the shaft member 30: 0.15 μm
Lubricating oil: liquid paraffin (viscosity: 4.4×10⁻³ Pa·s)
Lubrication method: application of lubricating oil; 45 mg
Oil clearance: 100 μm
Determination of seizure: the time (seconds) required from the start of rotational driving of the shaft member 30 until the friction torque reaches 4.8 N·m

The shaft member 30 was rotated under the above conditions, and the time (seconds) required from the start of rotational driving of the shaft member 30 until the friction torque reached 4.8 N·m was measured as the elapsed time until seizure. The elapsed time until seizure means the time required from the start of rotational driving of the shaft member 30 to the occurrence of seizure. The measurement results are shown in Table 1. In Table 1, it is indicated that the longer the elapsed time until seizure is, the higher the seizure resistance is, that is, the more excellent the seizure resistance is.

### —Evaluation of Improvement in Seizure Resistance Based on the Groove MG—

As shown in Table 1, all the test pieces of Examples provided with grooves MG had longer elapsed time until seizure than the test piece of a Comparative Example having no groove MG. Thus, evaluation results in which the test pieces of the resin layers 14 of the Examples have higher seizure resistance than the test piece of the comparative resin layer 17 of the Comparative Example have been obtained.

### Determination of Groove Shape Processability

The shape processability of the groove MG was evaluated for the test pieces of the Examples and the test pieces of the Comparative Examples. The evaluation results are shown in Table 2.

As shown in Table 2, when the Gr particle size was smaller than the depth of the groove MG, the rate of shape defects of the groove shape was small (the shape being normal). Further, as shown in Table 2, when the Gr particle size was more than the depth of the groove MG, the rate of shape defects of the groove shape was large (the shape being abnormal).

Specifically, for the test pieces of the Examples and the test pieces of the Comparative Examples, the surface of the groove MG of each of the bearings 10 and the comparative bearings 1000 was traced along the extending direction Z with a roughness measurement device (SE-3400, manufactured by Kosaka Laboratory Ltd.), and a surface shape enlarged curve along the extending direction Z of the groove MG was obtained. Then, for each of the test pieces of the Examples and the test pieces of the Comparative Examples, the average value av of the depths d of the plurality of grooves MG included in the surface shape enlarged curve and the standard deviation σ of the depth d of the groove MG were calculated.

Further, for each of the test pieces of the Examples and the test pieces of the Comparative Examples, among the included plurality of grooves MG, a groove MG having a depth d within the range of the standard deviation σ×½ with respect to the average value av was determined as normal, and a groove MG having a depth d outside the range was determined as defective. Then, for each of the test pieces of the Examples and the test pieces of the Comparative Examples, when the ratio of the grooves MG determined as defective among the included plurality of grooves MG was equal to or more than 20%, the shape of the groove MG was determined as abnormal. Further, for each of the test pieces of the Examples and the test pieces of the Comparative Examples, when the ratio of the grooves MG determined as defective among the included plurality of grooves MG was less than 20%, the shape of the groove MG was determined as normal, and when the ratio was equal to or more than 20%, the shape of the groove MG was determined as abnormal. The determination results are shown in Table 1 and Table 2.

As shown in Table 2, all the test pieces of the Examples were determined as the shape of the groove MG being normal. On the other hand, all the test pieces of the Comparative Examples were determined as the shape of the groove MG being abnormal.

The various materials and compositions thereof used in the above-described Examples are merely examples, and the present invention is not limited thereto. The resin layer 14 according to the present invention may further contain inevitable impurities, etc. The specific structure of the bearing 10 is not limited to that illustrated in FIGS. 1A to 2, or the like.

### REFERENCE SIGNS LIST

10 BEARING
12 BASE MATERIAL
14 RESIN LAYER
16 SYNTHETIC RESIN
16A PTFE PARTICLE
18 ADDITIVE
20 GRAPHITE
22 CLAY
40 COMPRESSOR

1. A bearing comprising:
a base material in a tubular shape; and
a resin layer joined to an inner peripheral surface of the base material, provided with, on a surface on a facing surface facing a shaft member accommodated to be opposed to the inner peripheral surface of the base material, a plurality of grooves running along a direction intersecting an extending direction of the shaft member, and containing a synthetic resin and an additive dispersed in the synthetic resin, wherein
an average particle size of the additive is less than a depth of the plurality of grooves.

2. The bearing according to claim 1, wherein
the additive includes at least one of graphite and clay.

3. The bearing according to claim 2, wherein
an average particle size of the graphite is equal to or more than 1.0 μm and less than 4.0 μm,
an average particle size of the clay is equal to or more than 2.0 μm and less than 3.5 μm, and
a depth of the groove is equal to or more than 4 μm and equal to or less than 7 μm.

4. The bearing according to claim 1, wherein
the synthetic resin contains PTFE particles.

5. A compressor comprising the bearing according to claim 1.
